(19) United States
(12) Patent Application Publication
(10) Pub. No.: US 2005/0240963 A1
(43) Pub. Date: Oct. 27, 2005

(54) Interactive gateway

(75) Inventors: David Preisman, New York, NY (US); Ann McGowan, New York, NY (US); Julia K. Veale, New York, NY (US); Christopher Lucas, Glenhead, NY (US)

Correspondence Address: VENABLE LLP, P.O. BOX 34385, WASHINGTON, DC, 20045-9998, US

(73) Assignee: Showtime Networks, Inc., New York, NY (US)

(21) Appl. No.: 10/828,190

(22) Filed: Apr. 21, 2004

(51) Int. Cl. H04N 5/445; H04B 7/216; H04N 7/173; G06F 13/00; H04N 7/16

(52) U.S. Cl. 725/44; 725/52; 725/53; 725/39; 725/45

(57) ABSTRACT

An interactive gateway creates a centralized location that allows subscribers and non-subscribers to premium television channels to navigate interactive television features and added value content for the programming services available on the subscription channels. The programming services available on the subscription channels may include movies, original series, boxing and family programming. The interactive gateway can also introduce subscribers and non-subscribers to all of the channels and interactive services available from a particular content provider. Although both subscriber and non-subscribers can access the interactive gateway, their experiences may be different. Different content is preferably provided based on a viewer's subscription status. Non-subscribers are presented with promotion material regarding the programming services to entice non-subscribers to become subscribers. Subscribers are presented with the added-value content, in-depth information about the programming services and other features such as reminders, recording capabilities and the like. Viewers that have advanced set top boxes may be able to access full digital video recording capabilities, as well as set reminders to view programs. The interactive gateway provides the ability to interact and access an extraordinary amount of content. The interactive gateway also provides an easy, entertaining television viewing experience and provides viewers with the choice, control and convenience that they desire.

### BACKGROUND OF THE INVENTION

Content such as television programming can include, e.g., a programming service. An example of a programming service is a subscription programming service, such as, e.g., SHOWTIME, available from SHOWTIME NETWORKS INC. of New York, N.Y., USA. Content providers offer programming services as a product. An example of a content provider is, e.g., SHOWTIME NETWORKS INC. Content distributors own networks that can be used to distribute content. An example of a content distributor is, e.g., COMCAST CORPORATION of Philadelphia, Pa., USA, DIRECTV of El Segundo, Calif., USA, ECHOSTAR COMMUNICATIONS CORPORATION of Englewood, Colo., USA, and TIME WARNER CABLE of Stamford, Conn., USA. Conventionally, content is distributed over various network platform types including, e.g., voice, data, cable television (CATV), wireless communications networks, direct broadcast satellite television, multichannel multipoint distribution service (MMDS) and wireless fidelity (WI-FI).

A large number of programming services can be provided to a viewer. The amount of channels a viewer has access to may number in the hundreds. It can be difficult for the viewer to determine what programs are on and to find the airdates and airtimes for their favorite programs. Programming guides have been introduced to help the viewer navigate through the large number of programming services available. Moreover, typical programming guides only provide information regarding the programs that are currently on and may cover hundreds of channels. Those few programming guides that do display programs that are showing days or weeks in advance are also typically based on when a programming is airing. As video on demand, digital video recorders (DVRs) and personal video recorders (PVRs) become more accessible, programs can be recorded and/or viewed as convenient for the viewer. The air time of a program is not a determining factor in what program to view. With the wide variety of options available, viewers require more information in order to help in making their viewing selections. Also, viewers desire in-depth information about their favorite shows and movies.

What is needed then is an improved technique of accessing enhanced content over content distribution systems that overcomes shortcomings of conventional solutions.

### SUMMARY OF THE INVENTION

An interactive gateway according to an embodiment of the invention creates a centralized location that allows subscribers and non-subscribers to television channels to navigate interactive television features and added value content for the programming services available on the subscription channels. The programming services available on the subscription channels may include movies, original series, boxing and family programming. The interactive gateway can also introduce subscribers and non-subscribers to all of the channels and interactive services available from a particular content provider. In addition, viewers that have advanced set top boxes may be able to access full digital video recording capabilities, as well as set reminders to view programs. The interactive gateway provides the ability to interact and access an extraordinary amount of content. The interactive gateway also provides an easy, entertaining television viewing experience and provides viewers with the choice, control and convenience that they desire.

Although both subscriber and non-subscribers can access the interactive gateway, their experiences may be different. It may be preferable to present non-subscribers with promotional material regarding the programming services in order to entice non-subscribers to become subscribers. Subscribers are presented with the added-value content, in-depth information about the programming services and other features such as reminders, recording capabilities and the like.

Another embodiment of the invention comprises a computer readable medium storing computer readable program code for causing a computer to perform the steps of: receiving channel selection information from a viewer; determining if the viewer is a subscriber; providing an interactive gateway to the viewer, the interactive gateway providing an interface listing programs available to the viewer on a plurality of different channels to which the viewer is a subscriber; receiving a request for information via the interactive gateway regarding one of the listed channels from the viewer; and providing the requested information based on the subscription status of the viewer.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. A preferred exemplary embodiment is discussed below in the detailed description of the following drawings:

FIG. 1 depicts an exemplary embodiment of an interactive television environment according to an exemplary embodiment of the present invention;

FIG. 2 depicts an exemplary embodiment of an interactive television client according to an exemplary embodiment of the present invention;

FIG. 3 depicts an exemplary embodiment of an interactive television according to an exemplary embodiment of the present invention;

FIG. 4 depicts a main introductory screen according to an exemplary embodiment of the present invention;

FIG. 5 depicts a series screen according to an exemplary embodiment of the present invention;

FIG. 6 depicts a series summary screen according to an exemplary embodiment of the present invention;

FIG. 7 depicts an episodes screen according to an exemplary embodiment of the present invention;

FIG. 8 depicts an episode summary screen according to an exemplary embodiment of the present invention;

FIG. 9 depicts a series cast screen according to an exemplary embodiment of the present invention;

FIG. 10 depicts a series character screen according to an exemplary embodiment of the present invention;

FIG. 11 depicts a character biography screen according to an exemplary embodiment of the present invention;

FIG. 12 depicts a movie screen according to an exemplary embodiment of the present invention;

FIG. 13 depicts a movie genre screen according to an exemplary embodiment of the present invention;

FIG. 14 depicts another movie genre screen according to an exemplary embodiment of the present invention;

FIG. 15 depicts a movie summary screen according to an exemplary embodiment of the present invention;

FIGS. 16A-16D depict insider screens according to an exemplary embodiment of the present invention;

FIG. 17 depicts a movie cast screen according to an exemplary embodiment of the present invention;

FIGS. 18A-18B depict actor in movie screens according to an exemplary embodiment of the present invention;

FIG. 19 depicts a quick pick screen according to an exemplary embodiment of the present invention;

FIG. 20 depicts a profile screen according to an exemplary embodiment of the present invention; and

FIG. 21 depicts another profile screen according to an exemplary embodiment of the present invention.

### DETAILED DESCRIPTION OF AN EXEMPLARY EMBODIMENT OF THE PRESENT INVENTION

A preferred embodiment of the invention is discussed in detail below. While specific implementations are discussed, it should be understood that this is done for illustration purposes only. A person skilled in the relevant art can recognize that other components and configurations may be used without parting from the spirit and scope of the invention.

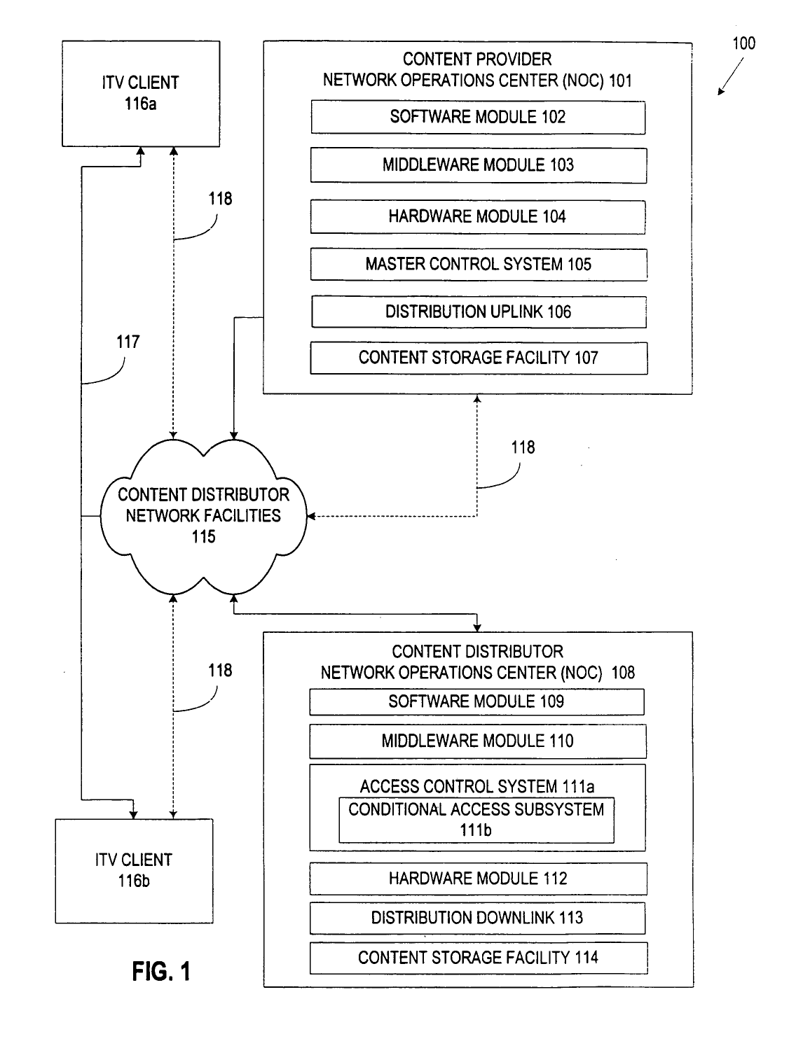

FIG. 1 depicts an exemplary embodiment of an interactive television (ITV) environment 100 that can be used to provide an interactive gateway according to an exemplary embodiment of the present invention. Although described below in a particular environment, the interactive gateway may be implemented in a variety of other environments.

ITV environment 100 in an exemplary embodiment can include a content provider network operation center (NOC) 101, a plurality of ITV clients 116a, 116b, and a content distributor NOC 108, coupled to one another by content distributor network facilities 115. The ITV environment 100 of FIG. 1 also illustrates, in an exemplary embodiment, a distribution channel 117 for broadcasting content to the ITV clients 116a, 116b from the content providers over the content distribution network 115, and a backchannel 118 for receiving interactive responses from the ITV clients 116a, 116b at the content provider.

Content provider NOC 101 can include, e.g., a software module 102 and a middleware module 103 running on top of a hardware module 104. The hardware module 104 may include a processor and associated memory. The content provider NOC 101 can also include a master control system 105 for assembling programming service content stored in a content storage facility 107 for distribution. The content provider NOC 101 can also include a distribution uplink 106 that can be used to upload content to the content distributor for distribution to ITV clients 116a, 116b.

Content distributor NOC 108 can include a software module 109, a middleware module 110, and an access control system 111a including, e.g., a conditional access subsystem 111b, running on a hardware module 112. A distribution downlink 113 can be used, in an exemplary embodiment, to download content from the content providers to the content distributor NOC 108, for temporary storage in content storage facility 114, prior to distribution via the content distributor network 115 to ITV clients 116a, 116b for viewing by viewers.

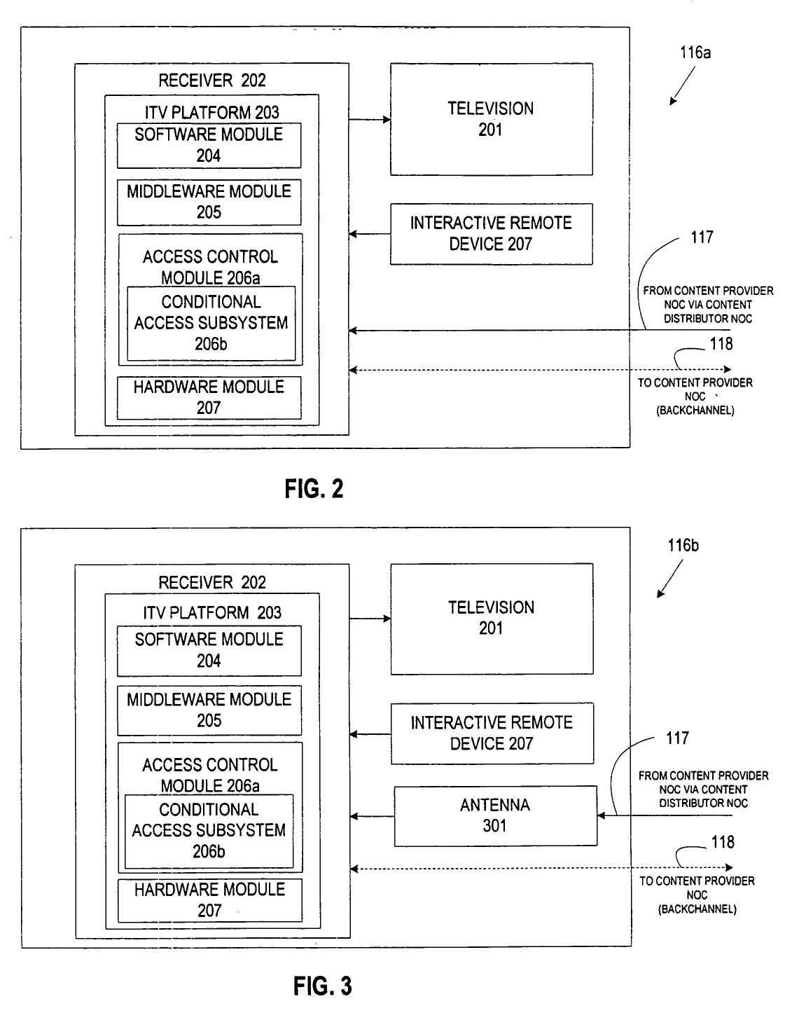

As shown in FIG. 2, ITV client 116a can include, in an exemplary embodiment, a television 201, a receiver 202, and an interactive remote device 207 such as a remote control. Receiver 202 can include, in an exemplary embodiment, ITV platform 203 that can include, e.g., a software module 204, a middleware module 205, an access control module 206a including, e.g., a conditional access subsystem 206b (such as a smart card), and hardware module 208. The hardware module 208 may include a processor and associated memory. The various modules may be combined into a set-top box. The set-top box may be configured to record programming services. As shown in FIG. 2, receiver 202 can be configured to receive content from content provider NOC 101 via a content distributor network 115 and content distributor NOC 108 directly via interface equipment, for example. The ITV platform 203 of FIG. 2 can be thought of as an example environment that could be used for a content distributor that uses a community access television (CATV, i.e., cable TV) network. Content is distributed to ITV 116a, 116b from the content provider over content distributor facilities as shown in line 117. Dotted line 118 represents an exemplary back channel 118 for sending interactive information to the content provider. The back channel is typically provided via a phone modem, via a broadband connection or through an existing two-way infrastructure such as a two-way cable system. Alternatively, as is shown in FIG. 3, receiver 202 can be configured to receive content from content provider NOC 101 via content distributor network 115 and content distributor NOC 108 via antenna 301, such as a satellite dish or the like.

The interactive television system described herein is exemplary only. The invention can also be implemented in many other types of interactive systems. For example, the content provider may communicate directly with the ITV clients 116a. Programming services, video and interactive television content may be provided directly to the viewer. Also, a back channel may be provided directly from the ITV client 116a to the content provider, without passing through a content distributor. A back channel is not necessary in all embodiments of the invention.

As will be understood by a person having ordinary skill in the art, content provider NOC 101 can distribute content via distribution uplink 106 to content distributor NOC 108. Content distributor NOC 108 can receive the content from content provider NOC 101 via distribution downlink 113. Content distributor NOC 108 can then distribute content to ITV clients 116a, 116b through content distributor network facilities 115. Examples of content distributors include, e.g., COMCAST CORPORATION of Philadelphia, Pa., USA, DIRECTTV of El Segundo, Calif. USA, ECHOSTAR COMMUNICATIONS CORPORATION of Englewood, Colo., USA, and TIME WARNER CABLE of Stamford, Conn. USA. Conventionally, content is distributed over various network platform types including voice, data, cable television (CATV), wireless communications networks, direct broadcast satellite television, multichannel multipoint distribution service (MMDS) and wireless fidelity (WI-FI).

The content provided to the ITV clients 116A may include a number of channels, such as broadcast network channels, cable channels, subscription channels, etc. These types of channels may be referred to as linear channels. Other types of programming services may also be provided, such as on demand video services. One of the channels may be an interactive gateway that provides information regarding programming services that are available on a selected subset of the plurality of channels provided to the viewer. The selected subset of channels may be further limited to those channels provided by a single content provider. For example, the selected subset of channels may include a number of premium or subscription channels such as Showtime, The Movie Channel, The Sundance Channel, etc., which are available from SHOWTIME NETWORKS INC. of New York, N.Y., USA.

The interactive gateway acts as a centralized application that allows subscribers and non-subscribers to navigate interactive television features and added value content for the programming services available on the subset of subscription channels. The programming services available on the subscription channels may include movies, original series, boxing and family programming. The interactive gateway can also introduce subscribers and non-subscribers to all of the channels and interactive services available from a particular content provider. In addition, the interactive gateway may provide a means of exploring high definition channels, video on demand and PVR/DVR features. Viewers that have advanced set top boxes may be able to access full digital video recording capabilities, as well as set reminders to view programs.

The interactive gateway provides the ability to interact and access an extraordinary amount of content. For example, the interactive gateway can also act as a gateway for video assets such as interviews, “making of” videos, behind the scenes clips, and trailers. The video assets may be displayed via the interactive gateway. The video may originate from a video on demand server, a hard drive on the client device, a linear feed, or IP delivery. The interactive gateway also provides an easy, entertaining television viewing experience and provides viewers with the choice, control and convenience that they desire. An example of an interactive gateway and its format is described in more detail below. Of course, other ways of presenting added value content and other services are also possible within the scope of the invention.

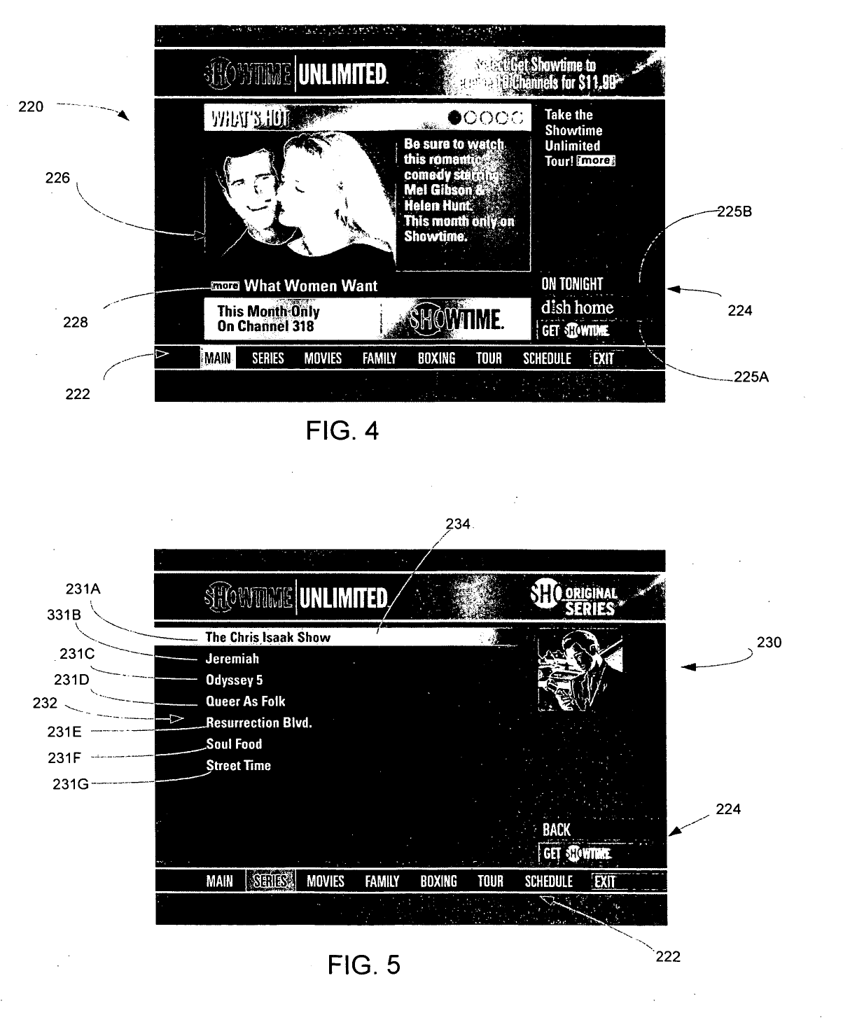

A viewer may enter the interactive gateway by selecting the appropriate channel number via their ITV client 116A. Alternatively, the interactive gateway may be accessed through a button on a remote control, through an on screen menu, or through a content distributor's portal, among many others. A main information screen for the interactive gateway is presented to the viewer. An example of a main screen 220 is shown in FIG. 4. The main screen 220 serves as an introduction to the interactive gateway and may also present promotional material to the viewer. The main screen 220 introduces the viewer to the primary navigation bar 222 and the secondary navigation bar 224. The primary and secondary navigation bars 222, 224 are the main means of navigation through the interactive gateway and are preferably displayed on all the screens described below. The primary and secondary navigation bars 222, 224 allow non-subscribers to order the subscription channels and/or enable subscribers to see what programming is being offered. The primary focus of the main screen 220 is content area 226. Content area 226 can cycle between various promotional messages. Each of the promotional messages can contain imagery, supporting text, a channel logo, and a linkable button to obtain more information regarding the promotion. The promotional information shown in FIG. 4 is information for a particular movie, “What Women Want”, being presented on one of the subset of subscription channels covered by the interactive gateway. Content area 226 includes a still image from the movie and accompanying text giving a summary of the movie. Content area 226 may also display video or include a link to view video. If the viewer desires to obtain additional information regarding the promotion, a more information button 228 in content area 226 may be selected. The viewer is then presented with additional information regarding the promotion, as is described in more detail below.

The type of information presented to the viewer via the main screen 220 can be tailored to the viewer depending on whether the viewer is a subscriber or a non-subscriber. If the viewer has a set-top box, the smartcard or other device in the set-top box may be queried in order to determine a subscription status. Additionally, the subscription status may be obtained from the content distributor e.g. through connection to the content distributor's billing system. The content presented on the main screen 220 may then be altered accordingly. A first set of content may be provided to subscribers and a second set of content may be provided to non-subscribers. The first set of content may include added value content such as behind the scenes information, trivia, filmographies, program promotions, etc. The content may also enable a subscriber to schedule recording of a program. The second set of content may include marketing materials. The second set of content is focused on getting the non-subscriber to become a subscriber.

The options presented to a viewer may also vary depending on whether the viewer is a current subscriber or not. For example, the secondary navigation bar 224 includes a get Showtime button 225A and an on tonight button 225B. The get Showtime button 225A is provided for ordering the subscription channels. Selecting button 225A takes non-subscribers through an ordering process. If the viewer is already a subscriber, button 225A may not be presented. The content and functionality is preferably tailored to the viewer's subscription status. Selecting the on tonight button 225B displays the programming that is available on the subset of subscription channels for the current date. If the viewer is a non-subscriber, this button may not be presented or not enabled. Additionally, the viewer may be presented with a record button. The record button may be used to schedule the recording of a program. The record button may be presented to both subscribers and non-subscribers. However, if a non-subscriber selects this button, a message is displayed stating that this feature is only available to subscribers. The tone of the content presented can be varied based on the subscription status of the viewer. Those that are non-subscribers can be presented with marketing content to entice them to select the order option. The subscription status of the viewer should continue to be monitored as the viewer navigates through the interactive gateway to ensure that the viewer is supplied with the appropriate content. If the subscription status of the viewer changes, for example by selecting the get Showtime button 225A and subscribing, the change in subscription status is detected. The viewer is then presented with subscriber content.

In order to provide an easy navigation system, the content available on the interactive gateway may be organized into different sections in a convenient menu displayed in the primary navigation bar 222. The various video programs available for viewing are organized into different categories. In the embodiment shown in FIG. 4, the categories include series, movies, family, and boxing. Using the interactive system described above, the viewer can select one of these categories in order to obtain more information on the programs available in that category. The viewer can navigate the main screen 220 and select the desired category using the remote control in a known manner. Once the viewer selects a category, the viewer is presented with an information screen for the selected category.

If the viewer selects the series category, a series screen is presented. The series screen may show the available programming services that are organized into the series category. An example of a series screen 230 is shown in FIG. 5. The primary and secondary navigation bars 222, 224 are included in the series screen 230. The viewer can use the navigation bars 222, 224 for navigation through the series screen 230. The names of the programs 231A-231G that are included in the series category are presented to the viewer in a list 232 in content area 226. A highlight bar 234 is used to indicate an active selection. When the list 232 is first presented to the viewer, the highlight bar 234 highlights the first series 231A in the list 232. The viewer can scroll through the list 232 using their remote control to select the desired series. Additionally, a still image, video or textual information for the active series may be provided in the content area 226. As the viewer scrolls through list 232, the image and text highlight (or state) are changed to correspond to the active series.

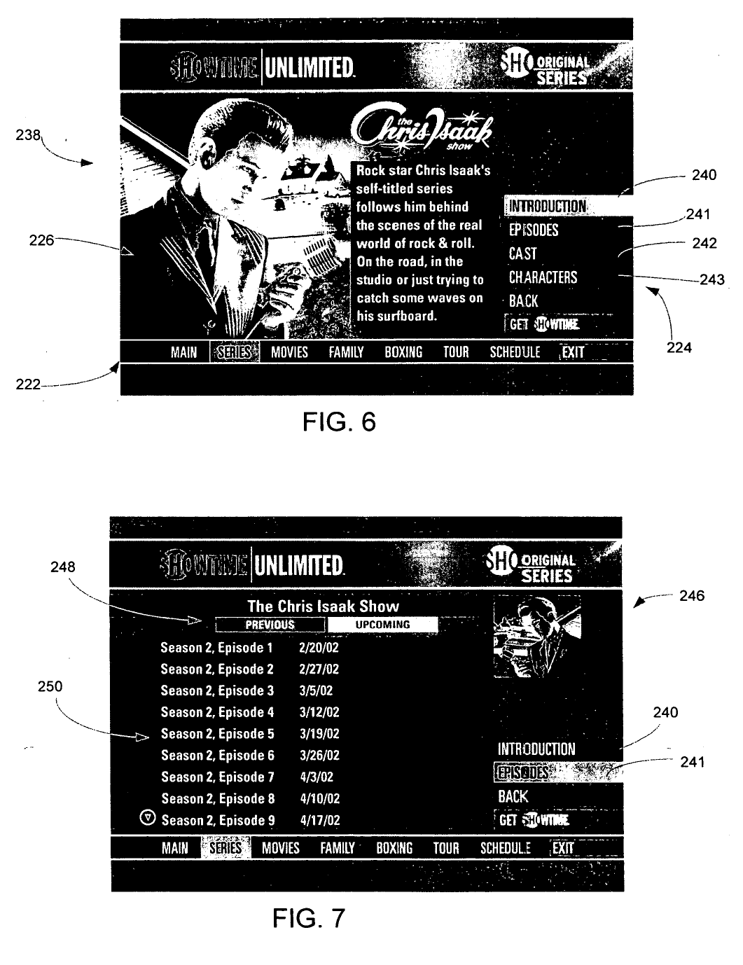

Once the viewer selects a particular series from list 232, the viewer is presented with an introduction screen for the selected series. An example of an introduction screen 238 is shown in FIG. 6. Here, the introduction screen correspond to series 231A, “The Chris Isaak Show”. The introduction screen 238 provides a general overview of the selected series. The introduction screen 238 can display a still image or video clip from the series in content area 226. A brief introductory textual message regarding the series may also be presented to the viewer. The secondary navigation bar 224 is modified to include selections which allow the viewer to obtain additional information regarding the series. The secondary navigation bar 224 includes introduction 240, episodes 241, cast 242 and characters 243 buttons. By selecting episodes 241 from the secondary navigation bar 224, the viewer has the ability to search for information regarding the series by episodes; selecting the cast category 242 from the secondary navigation bar 224 provides information on the cast; and selecting the characters category 243 provides information on the characters of the series. The introduction button 240 is highlighted in FIG. 6, as the introduction screen 238 is the current active screen. As the viewer navigates to the different screens, the appropriate button in secondary navigation bar 224 is highlighted to indicate the active screen.

If the viewer selects the episodes category from secondary navigation bar 224, the episodes screen 246 shown in FIG. 7 may be presented to the viewer. Note that the episodes button 241 is highlighted in secondary navigation bar 224, indicating that the episodes screen is the active screen. Information for both previously aired episodes and upcoming episodes may be provided via episode screen 246. An episode navigation bar 248 is provided for the viewer to select between previously aired episodes and upcoming episodes. In FIG. 7, upcoming episodes are selected. An episode list 250 of upcoming episodes for the active series 231A is shown in content area 226. Again, a highlight bar is used to indicate the active episode. The viewer can scroll through the various episodes to select a desired episode and obtain additional information about that episode.

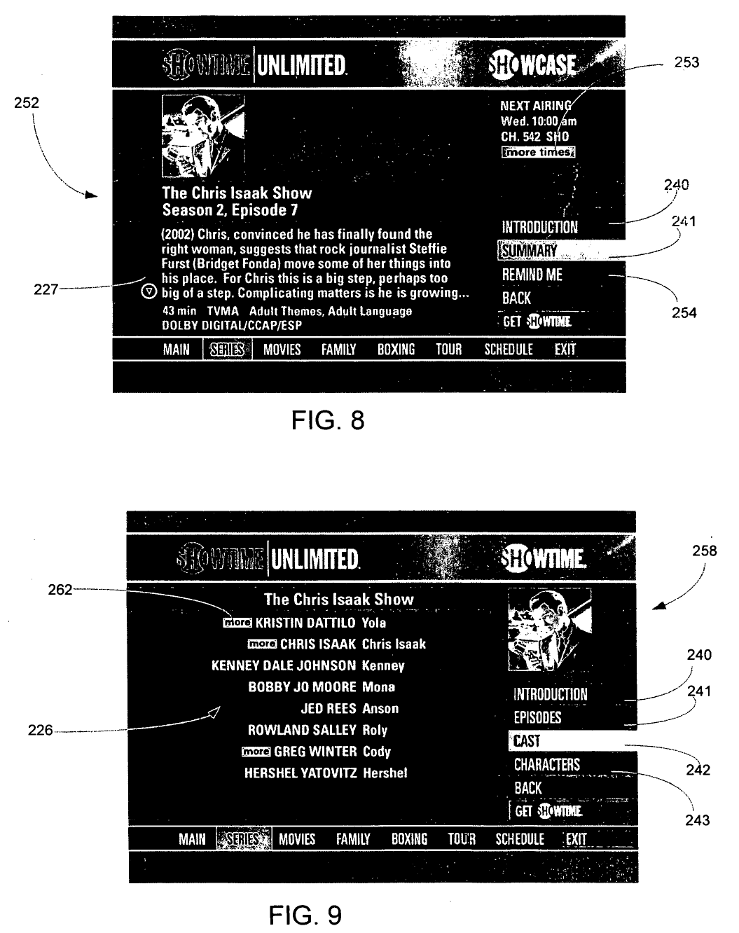

Selecting an episode from the list 250 displays a summary screen for the selected episode. An example of an episode summary screen 252 is shown in FIG. 8. The selected episode is identified and a summary of the episode is provided in the content area 226. The summary gives an overview of what happens in the selected episode. The summary of the selected episode may be displayed in a scrollable text portion 227 of content area 226. The summary of the episode can provide information regarding a length, rating, rating notes, sound, and closed captioned features for the episode. The next airdate and time for the episode may also displayed, if available. The times displayed are preferably adjusted for the viewer's time zone. If more than one airdate and time is available, a more times option 253 may also be provided.

The information provided to the viewer regarding the episode might entice the viewer to watch the show. Therefore, the viewer can be provided with a record/remind option. The record/remind option allows the viewer to record the episode or set a reminder that appears to remind the viewer when the episode next airs. Of course, this option is only available for episodes which have yet to air and for which an air date and time is available. A record/remind button 254 is presented in the secondary navigation bar 224 for this purpose. A play option, described below, may also be provided for available programming services, for example, programming services available via video on demand, stored or cached on a hard drive at the client device or otherwise available for play. Button 254 may read record or remind, depending of whether the viewer has a PVR or other recording means that the system can tie into. An application programming interface (API) may be provided that allows the PVR/DVR to be queried to determine its capabilities. In this example, no recording device has been located, so button 254 reads “Remind Me”. Once the viewer selects button 254, recording of the episode is automatically scheduled for recording or a reminder is automatically set. Again, an API may be provided to allow a recording request to be passed to the PVR/DVR. The recording request may include information identifying the program, a start time, duration, channel number, etc. In response to the recording request, the interactive gateway can send a confirmation, conflict or failure message. A pop up window may be displayed to inform the viewer that the recording/reminder is set or that other conditions exist.

If the cast button 242 is selected from the secondary navigation bar 224 on the series introduction screen 238, a cast screen is provided. The cast screen 258, an example of which is shown in FIG. 9, lists the actors and the roles they play in the series. The information on the cast screen 258 is not episode specific. In the example shown, the cast for “The Chris Isaak Show” is provided. A list 260 of the actors and their associated characters is displayed in content area 226. If an actor has an associated biography or filmography, a more link 262 is provided for that actor. Selecting the more link 262 displays the biography or filmography for the selected actor.

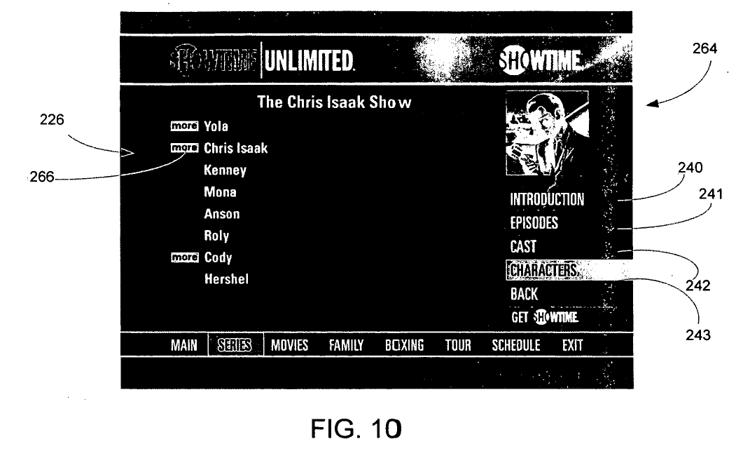

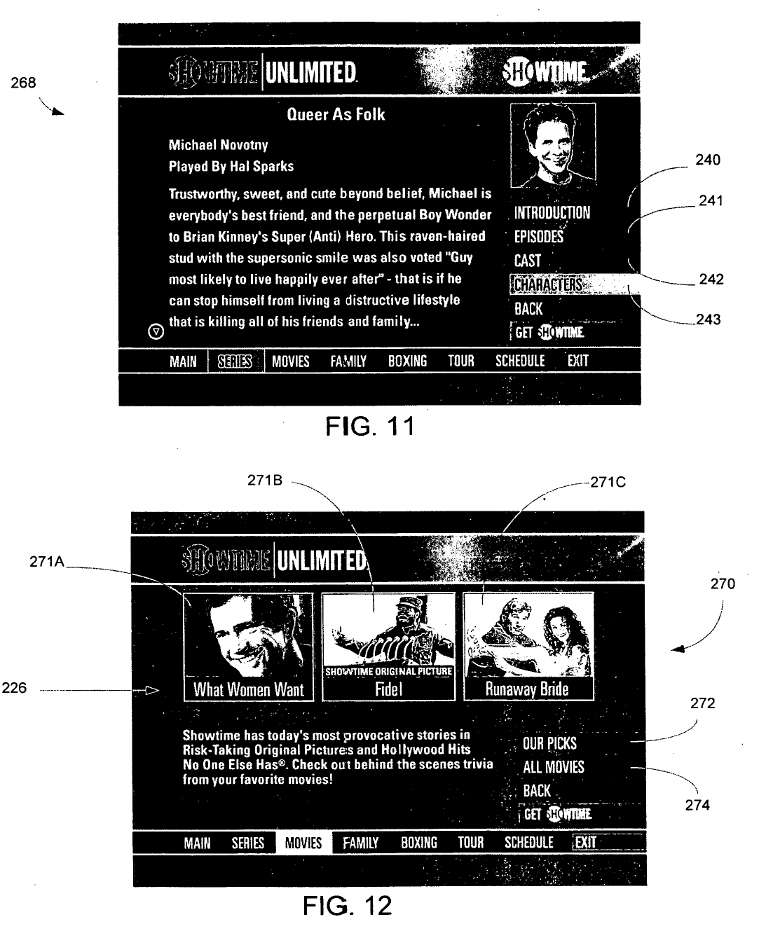

If the viewer selects the characters option 243 from the secondary navigation bar 224, a characters screen is presented. The characters screen displays a listing of the characters in the series, along with a short description of each character. In FIG. 10, characters screen 264 displays a list of characters for “The Chris Isaak Show” in content area 226. For those characters with a biography, a more link 266 is provided next to the character name. The viewer can select the more link 266 to access a short description of the character and biographical information for the selected character. This biographical information is specific to the character in the series, not the actor playing the character. An example of a character biography screen 268 for the hit Showtime series “Queer As Folk” is illustrated in FIG. 11. The character biography includes the character name, Michael Novotny, as well as the name of the actor who plays the character, Hal Sparks. Biographical information for the character is displayed in a scrolling text field in content area 226. Accordingly, the interactive gateway provides a viewer with an extraordinary amount of information about programs in the series category via the primary navigation bar 222 and subsequent screen displays.

Referring again to FIG. 4, a viewer can select from any of the other categories listed in primary navigation bar 222, such as movies, family, and boxing. An illustration of a movies screen 270 that is displayed when the viewer selects the movies category is shown in FIG. 12. Three different points of access are provided for the viewer to locate and obtain information about available programs in the movies category. A first point of access is via promotions that are shown on the movies screen 270. Promotions for the movies available on the various subscription channels included in the selected subset of channels are shown in content area 226. In the example shown, up to three promotions are centered across the content area 226. The promotions may include an image from the movie and accompanying text, such as the movie title. The promotions are preferably linkable. Thus, the viewer can select from the promotions displayed in content area 226 in order to access more information regarding a particular movie. When the viewer selects one of the movies from the promotion area, a movie summary screen, described below, that provides additional information regarding the movie is displayed.

If the viewer does not desire to select from one of the items shown in the promotion area, alternate points of access to movie information are provided via secondary navigation bar 224. Secondary navigation bar 224 includes an our picks button 272 and an all movies button 274. Both of these buttons provide access to functionality that helps the viewer navigate through the large number of available movies in order to quickly and easily locate the movie that the viewer is interested in. When the our picks button 270 is selected, the viewer is provided with a list of movie titles in content area 226. The movie titles are selected by someone other than the viewer, for example, the content provider, and are organized into an “Our Picks” category. The movies in the “Our Picks” category may be selected according to box office receipts, awards won, etc. The viewer can select a movie title from the list and obtain additional information about the movie via the movie summary screen, which is described in more detail below.

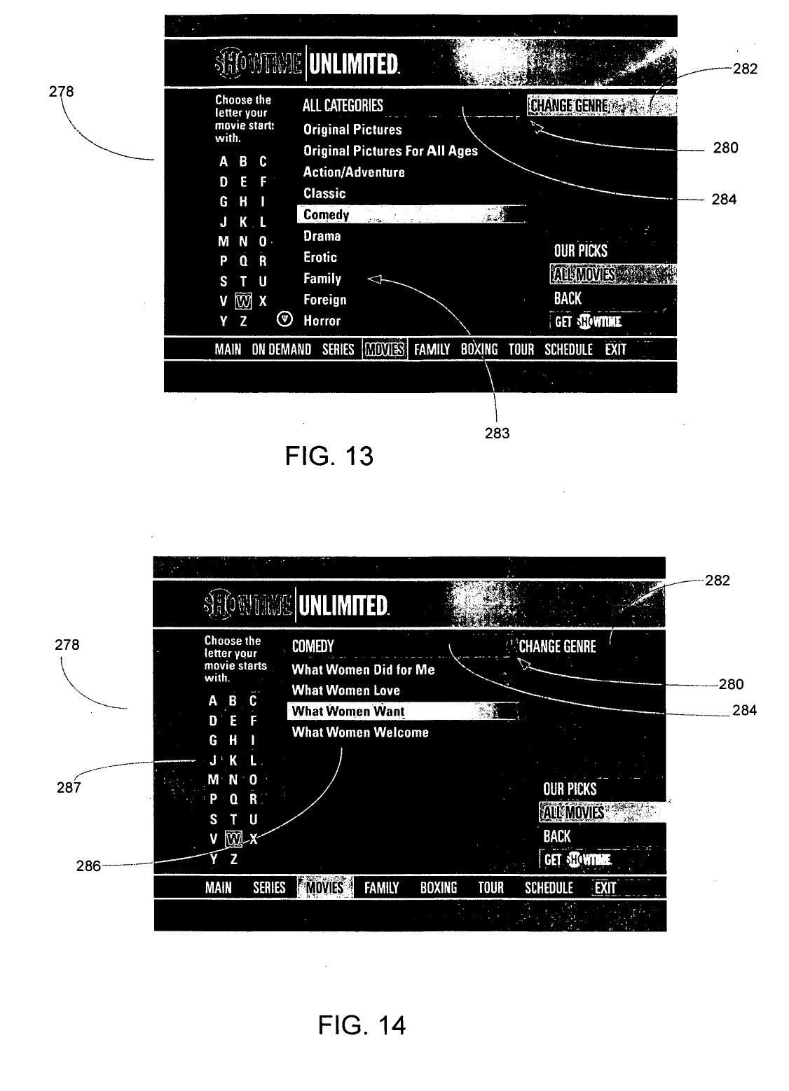

Secondary navigation bar 224 also includes an all movies button 274. As its name implies, all movies includes all of the movies available on all of the selected subscription channels. The number of movies available may be quite large and may be overwhelming to some viewers. Therefore, the all movies category is further broken down into sub-categories by genre. The genres may include classic, comedy, drama, etc. The viewer can filter through the list of movies using the different genres. FIGS. 13 and 14 show an example of screens presented to the viewer in order to help the viewer navigate through the large number of available movies. Screen 278 includes a genre navigation bar 280. The viewer can use the genre navigation bar 280 to select a genre from among the available movie genres. A change genre button 282 displays the available genres to the viewer. The available genres are displayed in content area 226. The viewer may scroll through the list 283 of available genres and select a genre of interest. This may be done using a highlight bar as described above. Here, the comedy genre is selected.

Once the viewer selects a genre, the available movies in that genre are displayed to the viewer in an alphabetical list 286 in content area 226. The genre navigation bar 280 displays the name of the active genre in field 284. The number of available movies in a genre may still be quite large and it may take an appreciable amount of time for the viewer to locate the desired movie. Therefore, screen 278 may also include twenty-six linkable buttons 287 that are labeled to correspond to the letters of the alphabet. The viewer can use these buttons to search through the movie titles in the active genre to locate a specific movie title. The viewer selects a button 287 and the available movie titles beginning with the corresponding letter are displayed in content area 226. In the example shown in FIG. 14, the button corresponding to the letter “w” is selected and the active genre is “comedy”, as shown in field 284. Based on these viewer selections, an alphabetical list of all movie titles in the comedy genre is shown in content area 226. The viewer can scroll through the list of movies and select a movie that they are interested in. This can be done using the remote control to highlight the desired movie, as described above. In this manner, the viewer can navigate through the movies available on all of the subscription channels covered by the interactive gateway. If the viewer is uncertain in which genre a movie may be classified, the viewer can select “all categories” from genre list 283. Then, all available movies are displayed and can be searched by title.

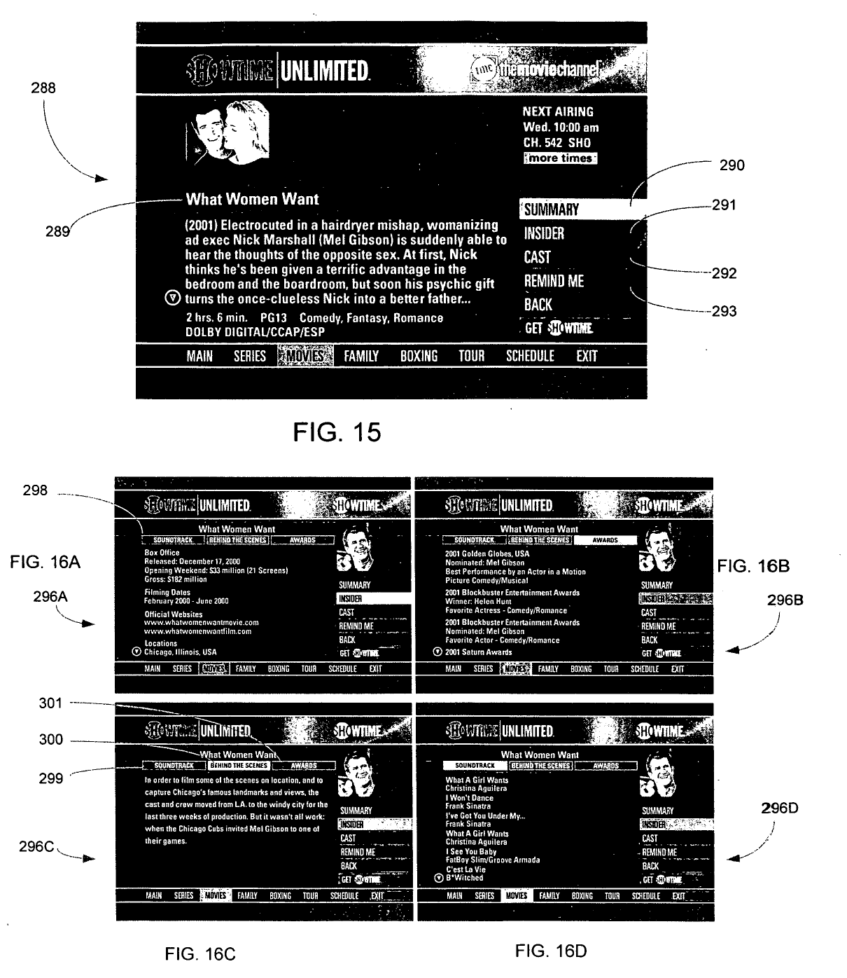

Once the viewer selects a particular movie, a movie summary screen for that movie is presented to the viewer. The movie summary screen can provide the viewer with an overview of the movie and other pertinent data, such as rating, running time, date released, genre, etc. An example of a movie summary screen 288 is shown in FIG. 15. In the example shown, the movie title 289 for the selected movie is displayed in content area 226. A description of the movie is also provided in a scrollable text portion 227 of the content area 226. Secondary navigation bar 224 provides the viewer with a menu to access various other options in order to obtain more in-depth information about the movie. Secondary navigation bar 224 includes summary 290, insider 291, cast 292, and remind/record 293 buttons. The summary button 290 in secondary navigation bar 224 is highlighted in FIG. 15 as the summary screen 288 is the active screen.

The insider button 291 in secondary navigation bar 224 allows the viewer to obtain additional, in-depth information about the movie, such as box office, release date, official web site, filming locations, soundtrack listing, behind the scenes, trivia, and awards. Examples of insider screens 296A-296B are shown in FIGS. 16A-16D. The insider screens can provide a wide array of different types of information. The insider information may be organized into categories. The categories may include soundtrack, behind the scenes, awards, and others. Insider screen 296 is provided with an insider navigation bar 298 via which the viewer can select from the different categories of insider information. Each category is assigned a respective button, which links to the appropriate information. In this example, insider navigation bar 298 includes buttons 299-301 for soundtrack, behind the scenes, and awards, respectively. The navigation bar 298 allows the viewer to toggle between the different types of insider information available. The various insider information regarding the movie can be displayed in a scrolling text portion of content area 226. Screen 296A displays a general insider screen presented to the viewer when they first enter the insider area. The information in content area 226 provides general background information on the movie. Screen 296B displays the awards information for the movie. Screen 296C provides behind the scene information about the movie, such as filming anecdotes and the like. Screen 296D provides soundtrack information for the movie.

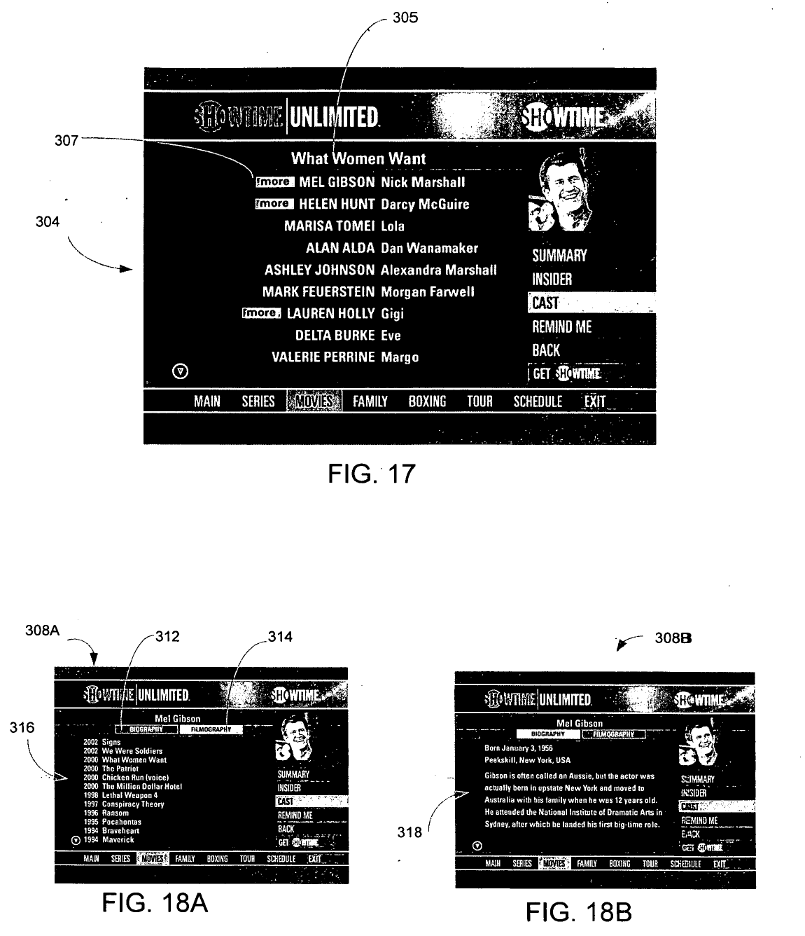

Secondary navigation bar 224 also provides a cast button 292. By selecting the cast button 292, a movie cast screen is presented. The movie cast screen may provide information about the actors in the film, their characters, and a biography or filmography for an actor. An example of a movie cast screen 304 is shown in FIG. 17. The title 305 of the movie is shown in content area 226. FIG. 17 shows the cast screen 304 for the movie “What Women Want”. A list 306 of the actors in the movie along with their associated characters is also provided in content area 226. If an actor has an associated biography or a filmography, a more link 307 is provided next to that actor name in list 306. The viewer can select the more link 307 in order to access more information regarding that actor.

When the more link 307 is selected, an actor in movie screen is presented to the viewer. The actor in movie screens 308A, B shown in FIGS. 18A, 18B display some of the information available. A filmography and/or biography for an actor may be provided. A navigation bar 310 is provided in screen 308. Navigation bar 310 includes a biography button 312 and a filmography button 314. The viewer can select these buttons to toggle between a filmography and biography for the actor. The filmography 316 shown in screen 308A illustrates all of the films in which the selected actor appeared. The biography 318 shown in screen 308B provides biographical information for the selected actor. The filmography and biography information may be presented in a scrolling text portion of content area 226. Thus, the viewer can obtain an extraordinary amount of information about movies in the movies category via the primary navigation bar 222 and subsequent screen displays.

Primary navigation bar 222 also allows the viewer to select from family and boxing categories. Selecting these categories presents the viewer with in-depth information via screens similar to those described above in connection with the series and movie categories. If the viewer selects the family category, an introductory screen is displayed. The introductory screen may present promotions related to family programming to the viewer. The viewer can select to retrieve additional information regarding the promotions or to search for a particular family program. The viewer is presented with a list of programs from which they can make a selection, similar to the process described above for movies. Once the viewer selects a particular program, a summary screen for the program is displayed. The summary screen provides the viewer with an overview of the program and all pertinent data such as rating, running time, date released, advanced program information, etc. In addition, the viewer may obtain additional information on the family movie or family series by selecting an insider option. Similar to the movie insider discussed above, the family insider allows the viewer to retrieve information regarding the box office, release date, web site, soundtrack listings, behind the scenes trivia and awards for the particular movie or series. The viewer can also select a cast option to retrieve information regarding the actors in the movie or program, their characters and select a specific biography or filmography for a member of the cast, similar to the functions described above in the movie cast screen. A record/reminder and/or play option may also be presented to the viewer.

If the viewer selects the boxing category from primary navigation bar 222, an introductory screen is presented that allows the viewer to select from a number of cycling promotions or to search for a particular program or other content. The viewer can search by events, fighters, or fights. Once the viewer selects a fighter or an event, the viewer is presented with a summary screen for that particular fight or fighters. At that point, the viewer can request information about a particular fighter, get insider information, set up a reminder, or record the event. If the viewer selects fighters, the viewer can also obtain information regarding the accomplishments of the fighter, the fighter profile, or complete ring record.

Accordingly, a viewer can use the interactive gateway to gain a vast amount of information regarding programs and movies being offered on the selected subset of channels, including the cast and characters of the movies and programs, and other in depth information. The interactive gateway provides a convenient and easy to use interface to navigate the large amount of information available, as well as to record programs and set reminders. A viewer may obtain programming information, added value content, schedule recording of programs, and access to subscription activation via the interactive gateway.

Some of the programming services covered by the interactive gateway may be available via video on demand. For these programs, a play button may be displayed next to the program name. The play button may be provided in menu 224 in addition to the record/remind button or in another location in any of the screens described above. The user can then select to play the program immediately instead or recording the program or waiting until the program's next scheduled air time. A link may also be provided to the on demand service.

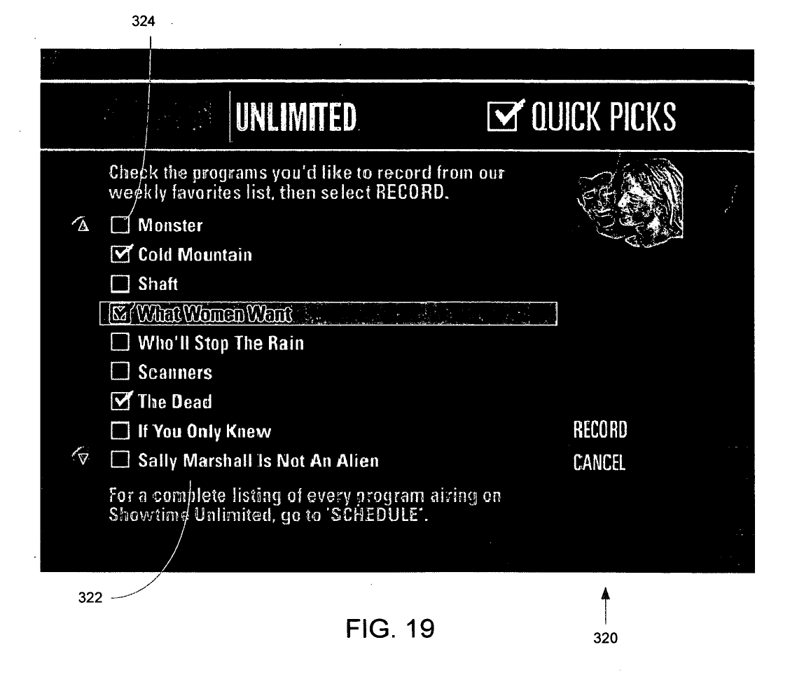

As mentioned above, the viewer may use the interactive gateway to initiate the recording of programming services or to set reminders to view a program. In the navigation process discussed above, the viewer navigates through a series of categories of programs and screens in order to locate the program desired. The option to set a recording/reminder is presented once a particular program is identified. Only one program for recording/reminding is scheduled at a time. In a further embodiment of the present invention, the viewer is provided with the ability to schedule recordings/reminders for many different programs from a single screen. The main screen 220 may be provided with buttons in the secondary navigation bar 224 for different recording options. A first of these options may be called “Quick Picks”. An example of a quick picks screen 320 is shown in FIG. 19. A list 322 of programs is presented to the viewer in content area 226. The list of programs can be presented in a scrolling textbox. The list 322 is selected from the programs available on the subset of channels covered by the interactive gateway. The programs displayed in list 322 are not selected by the viewer, but are predetermined in some manner. For example, the programs can be selected based on the programs' popularity, awards won, box office receipts, or other criteria. The quick picks screen 320 presents the viewer with a listing of select programs for a selected programming period. For example, the list may include top programs being presented during a particular month.

The viewer can select programs from list 322 for recording. A check box 324 is arranged next to each program title in list 322. The check box 324 is used to select the programs to be recorded. The viewer simply uses the remote control to place a checkmark in the check box 324 next to the desired program title. After the viewer makes their selections, a record button is actuated. The selected movies are then automatically scheduled for recording. The interactive gateway can interact with a recorder to set the recording of the program, for example using an API in the manner described above. Thus, the viewer can quickly and easily schedule recordings of programs for viewing at a later time.

Since the interactive gateway provides information regarding programming services that are available on a plurality of different channels, a conflict may arise when two or more programs that are selected for recording are scheduled to air on separate channels at the same time. On some devices, multiple programs cannot typically be recorded at the same time. When this occurs, a conflict resolution process should be provided. Thus, the viewer does not need to resolve each conflict themselves as is the case with typical DVRs. The recording of multiple programs can be achieved simply, with minimal effort and navigation.

In the conflict resolution process, data for each of the programs selected from the quick picks list is obtained. The data contains every air date for all of the programs included in the list. As the viewer selects programs from the quick picks list, an attempt is made to schedule the recording of each selected program. Late night showings of the selected programs, for example from 3 am-5 am, that are least likely to conflict with previously scheduled recordings are first attempted to be scheduled. The airdate and airtime for the newly selected show is compared to the airdates and airtimes for previously scheduled recordings. If there is a conflict with the recording of a selected program, the next airdate or airtime for the conflicting show is attempted to be scheduled. The system continues to move through the list of air dates/times for the program until an available recording time is located. If all airdates for the newly selected program result in a conflict with already scheduled recordings, the list of air dates/times for the previously scheduled conflicting program is examined. The airdate and airtime for the previously scheduled recording is compared to the airdates and airtimes for the newly selected show to determine alternate recording times for the previously scheduled program. If a recording time for both programs that are in conflict can still not be scheduled, the viewer is presented with a dialogue box with options to manually resolve the conflict.

Once a program is recorded, the viewer can watch the program at their leisure. After viewing a program that has been recorded, the viewer may desire to delete the program from his PVR, computer, etc. If there is no record that the program has already been recorded, viewed and/or subsequently deleted, the program may be re-recorded. Therefore, a list is maintained of all previously recorded programs. A cookie or the like indicating which programs have been recorded can be used. Before a program is recorded, the list is consulted to ensure that a program is not duplicated once it has been successfully recorded. Alternatively, the previously recorded program may be omitted from the quick picks list if the program has been recorded or viewed by that viewer.

The quick picks feature is quite different from existing viewer interfaces provided for PVR recording. Existing interfaces typically depend on a programming grid that displays all the programs currently airing. The viewer is forced to perform a search or browse through a series of categories and subcategories often based on air time and date in order to locate the program they desire to record. This process may work well if the viewer knows exactly the program that they are looking for and when it airs or the category if the viewer is looking for a particular type of program. However, neither of these approaches offers the convenience or flexibility of the quick picks list.

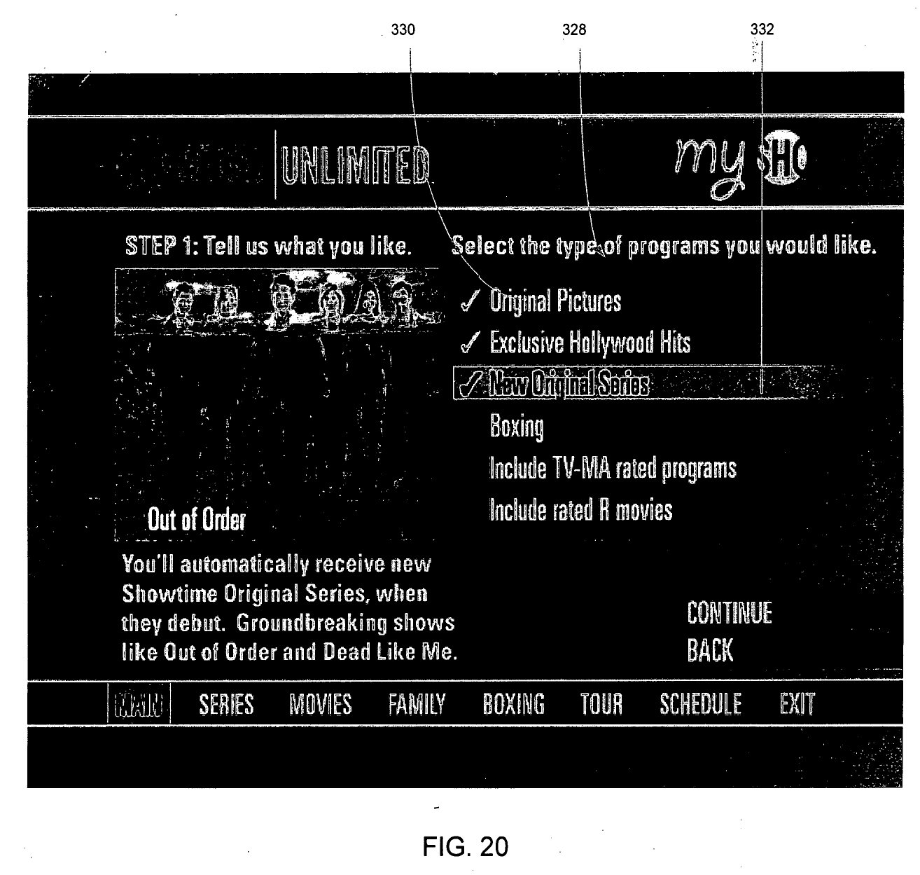

As mentioned above, the quick picks list is compiled based on criteria provided by someone other than the viewer. The interactive gateway can also provide a feature that allows the viewer to specify the types of programs that they wish to record. The viewer can create a profile via the interactive gateway. Programs that match the viewer profile are automatically determined. The matching programs are then automatically scheduled for recording. An example of the process of creating a viewer profile is shown in FIG. 20. Generally the viewer provides information regarding their likes and dislikes. This can be done by asking the user a series of questions and receiving the viewer's answers. The questions presented to the viewer may include general questions, for example, different types of programs in which the viewer is interested, and more specific questions regarding the specific types of programs the viewer is interested in, for example, boxing. In FIG. 20, a list 328 of different categories of programs is presented to the viewer. The viewer can scroll through the list and select the types of programs that they enjoy viewing and want to record. A check box 330 is provided next to each of the different categories of programs. The viewer can select the corresponding category by placing a check in the corresponding check box 330. In the example shown, the viewer has indicated that they prefer to view Showtime Original Pictures, exclusive Hollywood hits, and new original series. The highlight bar 332 is used to move through the list and select the appropriate categories. Based on the viewer's answers to the questions, a profile for the viewer is created.

Next, the programming services available on the various channels are examined to determine those that fit the viewer's preferences. Those programs that match the viewer profile are identified. The programs may be selected from a master list, such as quick picks. The master list is filtered based on the user's preferences. This can be done by assigning the different programs scores in different categories and then matching programs with high scores in the particular categories with viewer profiles with corresponding high scores. Those programs that are identified as matching the viewer profile are automatically scheduled for recording on the viewer's PVR/DVR, personal computer, or other recording device. A list of those programs that are scheduled for recording is also saved in a database. The viewer can access the list of programs scheduled for recording at any time. The viewer can edit the list to add or delete programs, as they desire. Conflicts in the scheduling of the recording of programs are handled in the same manner as described above for the quick picks feature. The viewer can also edit their preferences and change their profile if desired.

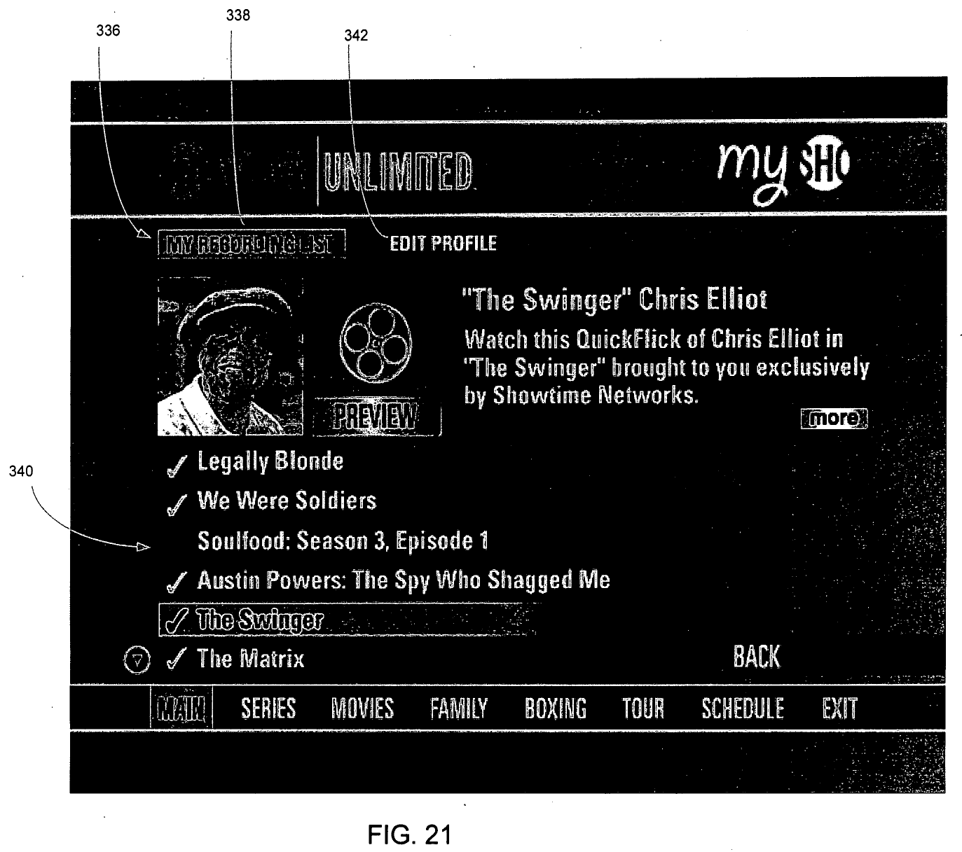

FIG. 21 illustrates a screen showing some of the viewer options available for the viewer to edit their profile. Navigation bar 336 provides the viewer the option of viewing those programs scheduled for recording by selecting the recording list button 338. A list 340 of programs scheduled for recording is then shown in a scrollable text area. The viewer can move the highlight bar through out the scrollable text area and make changes as desired. The edit profile button 342 allows the viewer to access their profile and make changes as desired.

Unless specifically stated otherwise, as apparent from the above discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to a preferred embodiment, it will be understood to those having ordinary skill in the art that changes in the above description or illustrations may be made with respect to formal detail without departing from the spirit and scope of the invention.

1. A programming service information system, comprising:
means for distributing a gateway channel, the gateway channel providing an interface showing programming service information for a subset of programming services;
a database to communicate with the means for distributing and to store the programming service information;
a processor to receive subscription information and to control the programming service information provided on the gateway channel based on the subscription information;
means for accessing subscription activation to the subset of programming services; and means for scheduling recording of at least one of the subset of programming services at a client device.

2. The system of claim 1, wherein the programming services include at least one of an on-demand channel and a linear channel.

3. The system of claim 1, further comprising means for displaying a list of the subset of programming services, displaying a link for programming services for which video on demand is available, receiving user input selecting the link, and playing the selected programming services based on the user input.

4. The system of claim 1, further comprising means for displaying a navigation screen, the navigation screen including a primary navigation bar, a secondary navigation bar, and a content area.

5. The system of claim 1, further comprising means for displaying a movie summary screen, the movie summary screen including links to cast information, character information, and insider information.

6. The system of claim 1, further comprising means for displaying a series screen including a number of linkable series programs.

7. The system of claim 6, wherein the series screen includes links to an episode screen, a cast screen, and a character screen.

8. The system of claim 1, further comprising:
means for receiving user information;
means for generating a viewer profile based on the user information;
means for matching programming services with the viewer profile; and
means for scheduling recording of the matching programs.

9. The system of claim 1, further comprising means for presenting a preselected list of programs to a viewer, receiving viewer input selecting program from the list to be recorded and automatically recording the selected programs.

10. The system of claim 9, further comprising means for automatically resolving conflicts between recording times of the selected programs.

11. A method for providing programming information, comprising:
providing a gateway channel to the viewer, the gateway channel providing an interface listing programs available on a set of subscription channels;
receiving a request via the gateway channel;
determining a subscription status of the viewer; and
providing a response to the request based on the subscription status of the viewer, the response including a first set of information if the subscription status indicates that the viewer is a subscriber and a second set of information if the subscription status indicates that the viewer is a non-subscriber.

12. The method of claim 11, further comprising:
continuing to monitor the subscription status of the viewer as the viewer navigates the gateway channel; and
changing content provided to the viewer based on the subscription status.

13. The method of claim 11, wherein the first set of information includes added value content regarding the subscription channels.

14. The method of claim 11, wherein the second set of information includes marketing materials.

15. The method of claim 11, wherein the request is a request to record a selected program provided on one of the plurality of different channels.

16. The method of claim 15, further comprising communicating with a set top box to record the selected program.

17. The method of claim 11, further comprising:
displaying profile questions on viewer equipment;
receiving responses to the profile questions;
determining a viewer profile based on the responses;
identifying programming on the selected channels that matches the viewer profile; and
scheduling recording of the identified programming at the viewer equipment.

18. The method of claim 17, further comprising:
determining air times for each of the identified programs;
determining a running time for the program; and
communicating airtime information, channel information, and a record order to a recorder for the identified programs.

19. The method of claim 17, further comprising:
determining if one of the programs conflict with the airing if another program;
determining all of the air times for the conflicting programs; and
scheduling the recording of one of the program to another airtime.

20. The method of claim 17, wherein the identifying step comprises:
storing a list of preselected programs;
filtering the list based on the viewer profile;
presenting the filter list to the viewer for selecting programs for recording; and
receiving user input identifying programs to record.

21. The method of claim 20, further comprising:
storing an indicator for previously recorded or viewed programs; and
checking the indicator for programs on the list; and
eliminating programs on the list for which an indicator is found.

22. A computer readable medium storing computer readable program code for causing a computer to perform the steps of:
providing a gateway channel to the viewer, the gateway channel providing an interface listing programs available on a set of subscription channels;
receiving a request via the gateway channel;
determining a subscription status of the viewer; and providing a response to the request based on the subscription status of the viewer, the response including a first set of information if the subscription status indicates that the viewer is a subscriber and a second set of information if the subscription status indicates that the viewer is a non-subscriber.

23. The computer readable medium of claim 22, wherein the request is a request to record a selected program provided on one of the plurality of different channels.

24. The computer readable medium of claim 22, further comprising computer readable program code for causing a computer to perform the step of communicating with a set top box to record the selected program.

25. The computer readable medium of claim 22, further comprising computer readable program code for causing a computer to perform the steps of:
displaying profile questions on viewer equipment;
receiving responses to the profile questions;
determining a viewer profile based on the responses;
identifying programming on the selected channels that matches the viewer profile; and causing a recording device at the viewer equipment to record the identified program.

26. The computer readable medium of claim 25, further comprising computer readable program code for causing a computer to perform the steps of:
determining air times for each of the identified programs;
determining a running time for the program; and
communicating airtime information, channel information, and a record order to a recorder for the identified programs.
